(19) United States
(12) Patent Application Publication
(10) Pub. No.: US 2025/0199869 A1
(43) Pub. Date: Jun. 19, 2025

(54) TECHNOLOGIES TO ACCESS ACCELERATORS

(71) Applicant: Intel Corporation, Santa Clara, CA (US)

(72) Inventors: Rathipriya GOPIKRISHNA, Bangalore (IN); Sanjita AGRAWAL, Bangalore (IN)

(21) Appl. No.: 19/066,985

(22) Filed: Feb. 28, 2025

(51) Int. Cl. G06F 9/50

(52) U.S. Cl. CPC G06F 9/5038

(57) ABSTRACT

Examples described herein relate to a processor that includes a general purpose processor core and an accelerator core and a plurality of distributed accelerator cores coupled to the processor. In some examples, the processor is to select an accelerator core from among the accelerator core and the plurality of distributed accelerator cores to perform at least one operation based on accelerator core utilization. In some examples, the accelerator core and the plurality of distributed accelerator cores perform encryption, decryption, compression, and/or decompression operations.

Data transmitted between network and storage devices is exposed to various threats, including unauthorized access, data tampering, and interception by malicious actors. Cryptographic operations protect data from unauthorized access but can impose computational loads on a central processing unit (CPU), causing delays, resource consumption, and reduced throughput. As the volume of data continues to grow, existing infrastructure can struggle to maintain high-speed transmission of encrypted data.

### BRIEF DESCRIPTION OF THE DRAWINGS

FIG. 1 depicts an example system.

FIG. 2 depicts an example operation of a system.

FIG. 3 depicts an example process.

FIG. 4 depicts an example computing system.

### DETAILED DESCRIPTION

To reduce computational loads on the CPU, the CPU can offload cryptographic and compression tasks to accelerator devices. However, where there are multiple accelerator devices available to perform tasks offloaded from the CPU, some of the accelerator devices may be overutilized, and throughput of accelerated operations can be slowed by the overutilized accelerator devices. Various examples can include a processor (e.g., CPU) that offloads operations to one or more accelerator cores in a pool of a plurality of accelerator cores to perform encryption, decryption, compression, decompression, or other operations. The one or more accelerator cores can be positioned within a package or system on chip (SoC) of the processor or be communicatively coupled to the one or more accelerator cores by device interfaces. The processor can select the one or more accelerator cores based at least on accelerator core utilization and potentially based on priority of the process that requested the operations to be performed by the accelerator core. Telemetry sensors can measure utilization, task load, and processing speeds of the general purpose processor and accelerator cores. The processor can detect underutilization or overloading of specific accelerator cores and assign workloads to underutilized accelerator cores or migrate workload from a queue of an overutilized accelerators to a queue of an underutilized accelerator cores. A coherent memory manager can monitor memory access patterns and memory usage across accelerator cores. Based on memory access patterns and memory usage across accelerator cores, the general-purpose processor can detect potential memory contention, fragmentation, or bottlenecks caused by improper memory allocation and proactively migrate data to reduce latency to access data.

In some examples, the plurality of accelerator cores can be distributed among devices such as a general purpose processor (e.g., CPU, graphics processing unit (GPU), or others), memory device, non-volatile storage (e.g., Just a Bunch of Flash (JBOF), solid state drive (SSD), or others), a network interface device, a memory controller, or a storage controller. Data transmitted between the device can be encrypted and/or compressed to provide secure transmission of data at rest and transit to a network. Accelerators cores can be organized into pools that serve different regions of a data center or geographies. The processor and accelerator cores can access shared memory so that the processor and the multiple accelerator cores can write data to a memory device or read data from the memory device by a single copy operation. Load balancing and coherent memory management work can prevent memory conflicts and task bottlenecks, resulting in higher throughput and reduced latency.

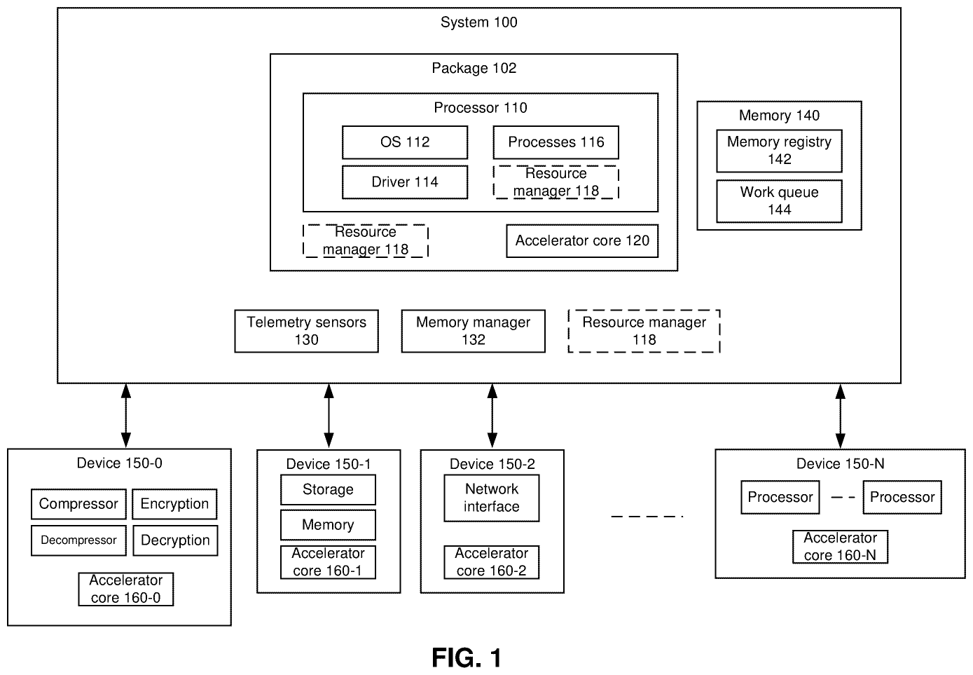

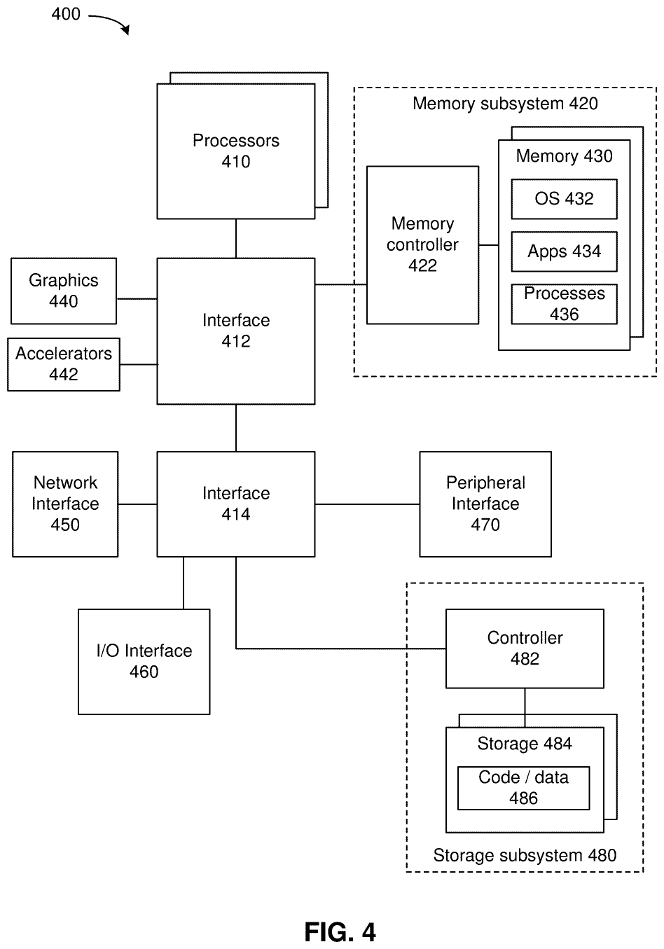

FIG. 1 depicts an example system. System 100 can include package 102, telemetry sensors 130, memory manager 132, memory 140, and other circuitry and software described at least with respect to FIG. 4. Package 102 can include a semiconductor package that encompasses or includes processor 110, resource manager 118, accelerator core 120, and potentially other circuitries described with respect to FIG. 1 or FIG. 4. A semiconductor package can include metal, plastic, glass, and/or ceramic casing that covers and encapsulates one or more semiconductor devices or integrated circuits (e.g., processor 110, resource manager 118, or accelerator core 120) and provides communications within or among the one or more semiconductor devices or integrated circuits.

Processor 110 can include one or more general purpose processors, including at least: a central processing unit (CPU), a processor core, graphics processing unit (GPU), neural processing unit (NPU), general purpose GPU (GPGPU), field programmable gate array (FPGA), application specific integrated circuit (ASIC), tensor processing unit (TPU), matrix math unit (MMU), or other circuitry. A processor core can include an execution core or computational engine that is capable of executing instructions. A core can access to its own cache and read only memory (ROM), or multiple cores can share a cache or ROM. Accelerator cores, slices, and/or cores can be homogeneous (e.g., same processing capabilities) and/or heterogeneous devices (e.g., different processing capabilities). A core can be sold or designed by Intel®, ARM®, Advanced Micro Devices, Inc. (AMD)®, Qualcomm®, IBM®, Nvidia®, Broadcom®, Texas Instruments®, or compatible with reduced instruction set computer (RISC) instruction set architecture (ISA) (e.g., RISC-V), among others.

In some examples, processor-executed operating system (OS) 112 or driver 114 can advertise capability of resource manager 118 to select an accelerator core among accelerator cores 120 and 160-0 to 160-N to perform a task based on utilization of the accelerator cores, complexity of a task, priority of a task, and/or other criteria. For example, OS 112 can call an application programming interface (API) to configure resource manager 118 to select an accelerator core among accelerator cores 120 and 160-0 to 160-N to perform a task based on utilization of the accelerators, complexity of a task, priority of a task, and/or other criteria.

Processor 110 can execute processes 116 that request packet processing, packet transmission, data compression, data decompression, data encryption, data decryption, data copying, or other operations to be performed by one or more of accelerator core 120 or accelerator cores 160-0 to 160-N, where N is an integer. Processes 116 can include one or more of: an application, process, thread, a virtual machine (VM), microVM, container, microservice, virtual function (VF), virtual device, or other virtualized execution environment.

Resource manager 118 can access tasks or requests for operations offloaded from processor 110 (e.g., OS 112, processes 116, or others) to one or more of accelerator cores 120 and 160-0 to 160-N via an API call or access to tasks written to queue 144 in memory 140. Based on telemetry information of utilization of one or more of accelerator cores 120 and 160-0 to 160-N, resource manager 118 can select one or more of accelerator cores 120 and 160-0 to 160-N to perform tasks written to queue 144. For example, telemetry sensors 130 can monitor and report to resource manager 118 at least a number of active connections, current processing load, and resource availability of one or more of accelerator cores 120 and 160-0 to 160-N. Resource manager 118 can perform a proxy by forwarding tasks to selected accelerator cores. For distributed data centers, multiple resource managers 118 can be deployed for forwarding tasks to regional accelerator cores or pools of accelerator cores for geographical load balancing of operations among accelerator cores, enhancing performance for cross-region data transmission.

Resource manager 118 can load balance use of accelerator cores 120 and 160-0 to 160-M by allocating tasks (e.g., encryption, compression, or others) to the least busy accelerator core (e.g., lowest number of busy cycles, and/or lowest number of active connections) or an accelerator core having utilization levels that are below a configured level. For example, the selected accelerator core can have a number of busy cycles and/or lowest number of active connections that are configured in configuration 146 to be an accepted level, by OS 112 or driver 114, such that operations can be assigned to the accelerator core.

Resource manager 118 can prioritize tasks based on time sensitivity and/or resource utilization by the task. Resource manager 118 can assign a higher priority to time-sensitive tasks (e.g., real-time video streaming, financial transactions). For example, OS 112 or driver 114 can set configuration 146 to indicate resource-intensiveness of tasks based on a level of clock cycles of an accelerator core to complete from historical data. Tasks that utilize more resources (e.g., encryption followed by compression, compression followed by encryption, decompression followed by decryption, decompression followed by encryption, or others) or process more data can be considered higher priority. Tasks that utilize fewer resources can be considered lower priority.

To distribute lower priority tasks to accelerator core(s), resource manager 118 can select accelerator core(s) that are underutilized or have an acceptable level of utilization by use of a round-robin, lowest numbers of active connections, or others. Lower-priority tasks can be queued or assigned to more heavily loaded cores to avoid delays of performing lower-priority tasks. To distribute higher priority tasks to accelerator core(s), resource manager 118 can select accelerator core(s) by use of a scheduling approach so that for larger, higher priority tasks or workloads giving priority to accelerator cores with greater processing capacity or those currently handling fewer high-priority tasks. Examples of scheduling approaches can include at least first in first out, priority of task, shortest job first, round robin, weighted round robin, or others.

Resource manager 118 can schedule the tasks among accelerator cores based on the topology and affinity of the data flow to distribute workloads among available accelerator cores based on real-time demand and core capacity based on load information captured by telemetry sensors 130 of accelerator cores 120 and 160-0 to 160-M. Resource manager 118 can ensure that tasks are distributed evenly among the accelerator cores, factoring in real-time processing capacity. Resource manager 118 can route different parts of the data to one or more accelerator cores, leveraging multi-core parallelism for tasks that utilize more resources such as compress-then-encrypt processes. Resource manager 118 can manage load distribution across multiple clusters or pools of accelerator cores, to provide geographic load balancing and redundancy in multi-region setups, such as cloud infrastructures.

In some examples, resource manager 118 can assign workloads to accelerator cores or slices in a hierarchical manner. For example, an accelerator core with an assigned workload can be considered a root of a tree and other accelerator cores can be a leaf nodes or a parent node to one or more leaf nodes. For example, an accelerator core with an assigned workload can act as a proxy to distribute work to the accelerator core and one or more other accelerator cores.

Resource manager 118 can be implemented as circuitry within package 102, a process executed by processor 110, accelerator core, firmware, or other circuitry.

For workloads distributed across multiple accelerator cores (e.g., encryption followed by compression or compression followed by encryption), coherent memory registry 142 ensures memory consistency, maintaining synchronization between accelerator cores and eliminating data corruption or redundancy. Coherent memory registry 142 can track and manage memory usage by accelerator cores, so that the memory state remains consistent and synchronized across cores. Coherent memory registry 142 can track which accelerator core or slice processes a segment of memory, preventing memory collisions and ensuring that a single core is responsible for a specific task at a given time. Coherent memory registry 142 can provide a unified view of memory regions accessible by accelerators cores 120 and 160-0 to 160-N so that memory mappings are up-to-date, reducing conflicts among accelerator cores when accessing shared data. Different slices can include different hardware circuitries and/or multiple processor-executed threads.

Coherent memory manager 132 can manage memory access and coordination between accelerator cores, proxy devices, and slices. Coherent memory manager 132 can provide memory consistency and coherence throughout the system, enabling faster processing, especially in multi-core environments.

Devices 150-0 to 150-N can perform operations offloaded from processor 110. Devices 150-0 to 150-N can include one or more of: a memory device, a storage device, a memory controller, a storage controller, a network interface device, or other circuitry, such as circuitry described with respect to FIG. 4. A network interface device can include one or more of: a network interface controller (NIC), a remote direct memory access (RDMA)-enabled NIC, SmartNIC, router, switch, forwarding element, infrastructure processing unit (IPU), data processing unit (DPU), edge processing unit (EPU), or Amazon Web Services (AWS) Nitro Card. An edge processing unit (EPU) can include a network interface device that utilizes processors and accelerators (e.g., digital signal processors (DSPs), signal processors, or wireless specific accelerators for Virtualized radio access networks (vRANs), cryptographic operations, compression/decompression, and so forth). A Nitro Card can include various circuitry to perform compression, decompression, encryption, or decryption operations as well as circuitry to perform input/output (I/O) operations.

Devices 150-0 to 150-N can include respective accelerator cores 160-0 to 160-N. Accelerator cores 120 and 160-0 to 160-N can perform one or more of: data compression, data decompression, data encryption, data decryption, data copy offload, or other operations. Processor 110 can access devices 150-0 to 150-N and associated accelerator cores 160-0 to 160-N via device interfaces (e.g., Peripheral Component Interconnect express (PCIe), Compute Express Link (CXL), or others).

Accelerator cores 160-0 to 160-N can include Intel® QuickAssist Technology (Intel® QAT). Accelerator cores can be organized into slices. A slice can include a logical partition of accelerator core and a slice can be configured to handle specific types of workloads, such as cryptographic operations (e.g., encryption, decryption) or data compression. By dividing the accelerator core into multiple slices, multiple slices can perform parallel processing of tasks. Accelerator cores can perform parallel processing of multiple tasks across different accelerator cores by slice management. Dynamic data slicing can distribute workloads evenly or unevenly across available accelerator cores. Accelerator core slices can become fully utilized, leading to efficient system performance.

In some examples, system 100 can be implemented as part of a system-on-a-chip (SoC). Various examples of system 100 can be implemented as a discrete device, in a die, in a chip, on a die or chip mounted to a circuit board, in a package, or between multiple packages, in a server, in a CPU socket, or among multiple servers.

Processor 110 can access one or more of devices 150-0 to 150-N by die-to-die communications; chipset-to-chipset communications; circuit board-to-circuit board communications; package-to-package communications; and/or server-to-server communications. Die-to-die communications can utilize Embedded Multi-Die Interconnect Bridge (EMIB) or an interposer. Components of FIG. 1 (e.g., processor 110, devices 150-0 to 150-N, or others) can be enclosed in one or more semiconductor packages. A semiconductor package can include metal, plastic, glass, and/or ceramic casing that encompass and provide communications within or among one or more semiconductor devices or integrated circuits.

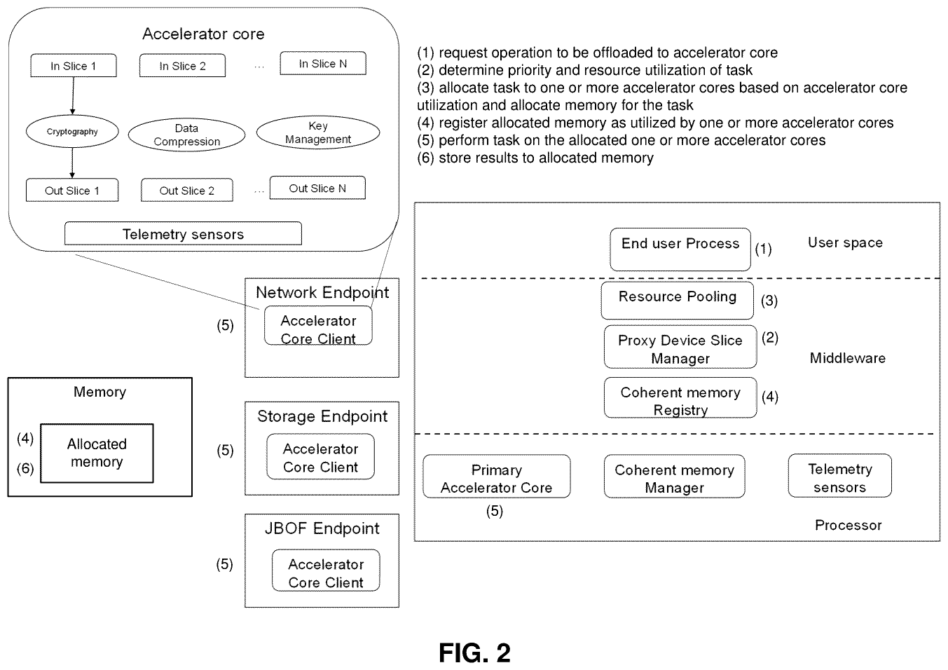

FIG. 2 depicts an example operation of a system. At (1), a processor-executed process can initiate a request to perform a task. The task can be associated at least with an operation (e.g., encryption, decryption, compression, decompression, or others), time sensitivity (e.g., real-time encryption), and resource utilization (e.g., size of data processed, decompression or compression followed by encryption, encryption followed by decompression or compression, decryption followed by decompression or compression, encryption followed by decompression or compression, or others). In some examples, a descriptor for the task can indicate one or more of: the operation, memory address of data to be processed, time sensitivity, and/or resource utilization. The descriptor can be stored in a work queue.

At (2), a processor-executed proxy device slice manager middleware can determine one or more of the following for the task: a priority (e.g., time sensitivity) and resource utilization (e.g., level of accelerator core utilization), or others. At (3), a processor-executed resource polling can monitor utilization of accelerator cores using telemetry sensors and based on utilization of the accelerator cores and priority, the processor-executed proxy device slice manager can select one or more accelerator cores to perform the task based on accelerator core utilization or priority level of the task. The accelerator cores can be positioned in one or more of: a network endpoint, storage endpoint, flash device endpoint, the processor, or other devices. In some examples, the processor-executed proxy device slice manager can select one or more slices of an accelerator core to perform the task.

At (3), the processor-executed proxy device slice manager can allocate memory for data to be processed for the task by communicating with the coherent memory manager. At (4), coherent memory manager can register the allocated memory with the coherent memory registry so that the allocated memory is accessible by a single accelerator core or group of accelerator cores that process the same data. At (5), the selected accelerator core can perform the task and store the results in the allocated memory. At (6), the processor-executed middleware can indicate that results are available in the allocated memory to the requester application.

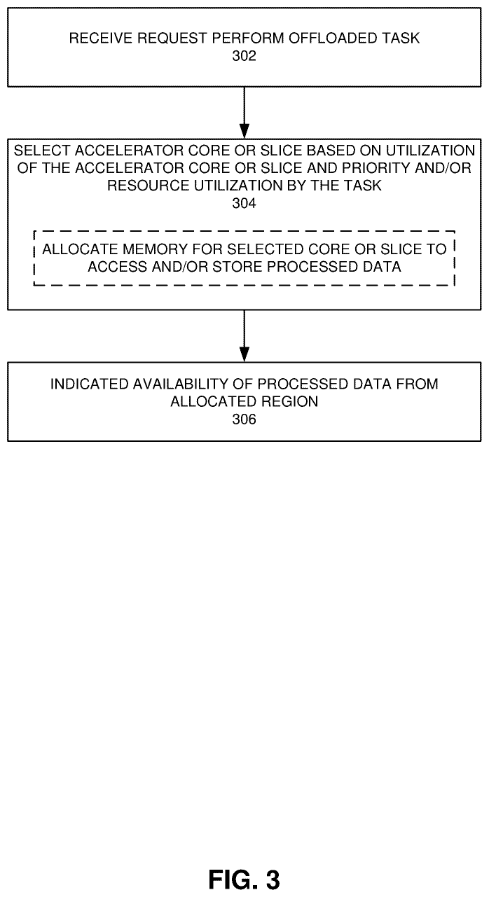

FIG. 3 depicts an example process. The process can be performed by a circuitry, processor-executed software, firmware, or others. At 302, a request to perform a task or workload can be performed. The task or workload can specify a particular operation to perform on data and specify a memory address range (e.g., starting address and length) of the data in memory.

At 304, a priority and resource utilization of the task or workload can be determined and one or more accelerator cores can be selected based on the utilization of one or more accelerator cores and/or priority of the task or workload. For example, the utilization of one or more accelerator cores can indicate a number of active threads, active cycles over a time period, complexity of the task or workload, current processing load, or other indicators of busyness. For example, the priority can be based on a time-to-completion goal for the task or workload or utilization of accelerator cores to complete the task or workload. For example, the resource utilization can represent a number of slices or accelerator cores to complete the task or workload to achieve a time-to-completion goal for the task or workload.

One or more slices or accelerator cores can be selected to perform the task or workload based on selection of a least busy slice or accelerator core, round robin, lowest numbers of active tasks, load balancing among one or more accelerator cores, or other techniques described herein.

At 304, memory addresses can be allocated to the selected one or more accelerator cores so that the selected one or more accelerator cores can read and/or write data to the allocated memory addresses. The task or workload can be submitted to the selected one or more accelerator cores to perform the task or workload.

At 306, based on completion of performance of the task or workload, an indication can be made that data is available to read from the allocated memory addresses.

FIG. 4 depicts a system. In some examples, selection of one or more accelerator cores can be performed based on utilization of the accelerator cores or slices of accelerators 442, complexity of a task, priority of a task, and/or other criteria, as described herein. Various examples of a processor socket can include circuitry and software described with respect to FIG. 4. System 400 includes processor 410, which provides processing, operation management, and execution of instructions for system 400. Processor 410 can include any type of microprocessor, central processing unit (CPU), graphics processing unit (GPU), XPU, processing core, or other processing hardware to provide processing for system 400, or a combination of processors. An XPU can include one or more of: a CPU, a graphics processing unit (GPU), general purpose GPU (GPGPU), and/or other processing units (e.g., accelerators or programmable or fixed function FPGAs). Processor 410 controls the overall operation of system 400, and can be or include, one or more programmable general-purpose or special-purpose microprocessors, digital signal processors (DSPs), programmable controllers, application specific integrated circuits (ASICs), programmable logic devices (PLDs), or the like, or a combination of such devices. Processor 410 can include multiple processors and multiple processors can be embodied as processor sockets.

In one example, system 400 includes interface 412 coupled to processor 410, which can represent a higher speed interface or a high throughput interface for system components, such as memory subsystem 420 or graphics interface components 440, or accelerators 442. Interface 412 represents an interface circuit, which can be a standalone component or integrated onto a processor die. Where present, graphics interface 440 interfaces to graphics components for providing a visual display to a user of system 400. In one example, graphics interface 440 generates a display based on data stored in memory 430 or based on operations executed by processor 410 or both. In one example, graphics interface 440 generates a display based on data stored in memory 430 or based on operations executed by processor 410 or both.

Accelerators 442 can be a programmable or fixed function offload engine that can be accessed or used by a processor 410. For example, an accelerator core or slice among accelerators 442 can provide data compression (DC) capability, cryptography services such as public key encryption (PKE), cipher, hash/authentication capabilities, decryption, or other capabilities or services. In some cases, accelerators 442 can be integrated into a CPU socket (e.g., a connector to a motherboard or circuit board that includes a CPU and provides an electrical interface with the CPU). For example, accelerators 442 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 442 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 420 represents the main memory of system 400 and provides storage for code to be executed by processor 410, or data values to be used in executing a routine. Memory subsystem 420 can include one or more memory devices 430 such as read-only memory (ROM), flash memory, one or more varieties of random access memory (RAM) such as DRAM, or other memory devices, or a combination of such devices. Memory 430 stores and hosts, among other things, operating system (OS) 432 to provide a software platform for execution of instructions in system 400. Additionally, applications 434 can execute on the software platform of OS 432 from memory 430. Applications 434 represent programs that have their own operational logic to perform execution of one or more functions. Processes 436 represent agents or routines that provide auxiliary functions to OS 432 or one or more applications 434 or a combination. OS 432, applications 434, and processes 436 provide software logic to provide functions for system 400. In one example, memory subsystem 420 includes memory controller 422, which is a memory controller to generate and issue commands to memory 430. It will be understood that memory controller 422 could be a physical part of processor 410 or a physical part of interface 412. For example, memory controller 422 can be an integrated memory controller, integrated onto a circuit with processor 410.

Applications 434 and/or processes 436 can refer instead or additionally to a virtual machine (VM), container (e.g., Docker container), microservice, processor, or other software. Various examples described herein can perform an application composed of microservices, where a microservice runs in its own process and communicates using protocols (e.g., application programming interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 432 can perform or configure a resource manager to select an accelerator core among accelerator cores or slices of accelerator 442 to perform a task offloaded from processors 410 based on utilization of the accelerator cores, complexity of a task, priority of the task, and/or other criteria.

In some examples, OS 432 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

While not specifically illustrated, it will be understood that system 400 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 400 includes interface 414, which can be coupled to interface 412. In one example, interface 414 represents an interface circuit, which can include standalone components and integrated circuitry. In one example, multiple user interface components or peripheral components, or both, couple to interface 414. Network interface 450 provides system 400 the ability to communicate with remote devices (e.g., servers, workstations, or other computing devices) over one or more networks. Network interface 450 can include an Ethernet adapter, wireless interconnection components, cellular network interconnection components, USB (universal serial bus), or other wired or wireless standards-based or proprietary interfaces. Network interface 450 can transmit data to a device that is in the same data center or rack or a remote device, which can include sending data stored in memory. Network interface 450 can receive data from a remote device, which can include storing received data into memory. In some examples, packet processing device or network interface device 450 can refer to one or more of: a network interface controller (NIC), a remote direct memory access (RDMA)-enabled NIC, SmartNIC, router, switch, forwarding element, infrastructure processing unit (IPU), or data processing unit (DPU).

In one example, system 400 includes one or more input/output (I/O) interface(s) 460. I/O interface 460 can include one or more interface components through which a user interacts with system 400. Peripheral interface 470 can include any hardware interface not specifically mentioned above. Peripherals refer generally to devices that connect dependently to system 400.

In one example, system 400 includes storage subsystem 480 to store data in a nonvolatile manner. In one example, in certain system implementations, at least certain components of storage 480 can overlap with components of memory subsystem 420. Storage subsystem 480 includes storage device(s) 484, which can be or include any conventional medium for storing large amounts of data in a nonvolatile manner, such as one or more magnetic, solid state, or optical based disks, or a combination. Storage 484 holds code or instructions and data 486 in a persistent state (e.g., the value is retained despite interruption of power to system 400). Storage 484 can be generically considered to be a “memory,” although memory 430 is typically the executing or operating memory to provide instructions to processor 410. Whereas storage 484 is nonvolatile, memory 430 can include volatile memory (e.g., the value or state of the data is indeterminate if power is interrupted to system 400). In one example, storage subsystem 480 includes controller 482 to interface with storage 484. In one example controller 482 is a physical part of interface 414 or processor 410 or can include circuits or logic in both processor 410 and interface 414.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 400 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications. Die-to-die communications can utilize Embedded Multi-Die Interconnect Bridge (EMIB) or an interposer. Components of examples described herein can be enclosed in one or more semiconductor packages. A semiconductor package can include metal, plastic, glass, and/or ceramic casing that encompass and provide communications within or among one or more semiconductor devices or integrated circuits. Various examples can be implemented in a die, in a package, or between multiple packages, in a server, or among multiple servers. A system in package (SiP) can include a package that encloses one or more of: an SoC, one or more tiles, or other circuitry.

In an example, system 400 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.′”

Illustrative examples of the devices, systems, and methods disclosed herein are provided below. An embodiment of the devices, systems, and methods may include any one or more, and any combination of, the examples described below.

Example 1 includes one or more examples and includes an apparatus that includes: a processor comprising a general purpose processor core and an accelerator core and a plurality of distributed accelerator cores coupled to the processor, wherein the processor is to select an accelerator core from among the accelerator core and the plurality of distributed accelerator cores to perform at least one operation based on accelerator core utilization and wherein the accelerator core and the plurality of distributed accelerator cores perform encryption, decryption, compression, and/or decompression operations.

Example 2 includes one or more examples, wherein the plurality of distributed accelerator cores are positioned in a plurality of devices coupled to the processor by associated device interfaces.

Example 3 includes one or more examples, wherein the processor is to select the accelerator core from among the accelerator core and the plurality of distributed accelerator cores to perform the at least one operation based on a priority level of the at least one operation.

Example 4 includes one or more examples, wherein the processor is to select a second accelerator core from among the accelerator core and the plurality of distributed accelerator cores to perform second at least one operation based on accelerator core utilization.

Example 5 includes one or more examples, wherein based on a priority of the at least one operation being higher than a priority of the second at least one operation, the processor is to select the accelerator core with a lower accelerator core utilization than a utilization of the second accelerator core.

Example 6 includes one or more examples, wherein based on a priority of the at least one operation being higher than a priority of the second at least one operation, the processor is to select multiple accelerator cores to perform the at least one operation.

Example 7 includes one or more examples, wherein the accelerator core and the plurality of distributed accelerator cores comprise heterogeneous accelerator cores.

Example 8 includes one or more examples, and includes a package that encapsulates the general purpose processor core and the accelerator core.

Example 9 includes one or more examples, and includes a method that includes selecting an accelerator core from among an accelerator core associated with a processor and a plurality of distributed accelerator cores to perform at least one operation based on accelerator core utilization and wherein the accelerator core and the plurality of distributed accelerator cores perform encryption, decryption, compression, and/or decompression operations, wherein a package encompasses the accelerator core and the processor.

Example 10 includes one or more examples, wherein the plurality of distributed accelerator cores are positioned in a plurality of devices coupled to the processor by associated device interfaces.

Example 11 includes one or more examples, and includes the processor selecting the accelerator core from among the accelerator core and the plurality of distributed accelerator cores to perform the at least one operation based on a priority level of the at least one operation.

Example 12 includes one or more examples, and includes the processor selecting a second accelerator core from among the accelerator core and the plurality of distributed accelerator cores to perform second at least one operation.

Example 13 includes one or more examples, and includes based on a priority of the at least one operation being higher than a priority of the second at least one operation, the processor selecting the accelerator core with a lower accelerator core utilization than second accelerator core to perform the at least one operation and based on the priority of the second at least one operation being higher than the priority of the at least one operation, the processor selecting multiple accelerator cores to perform the second at least one operation.

Example 14 includes one or more examples, wherein based on a priority of the at least one operation being higher than a priority of the second at least one operation, the processor selecting multiple accelerator cores to perform the at least one operation.

Example 15 includes one or more examples, wherein the accelerator core and the plurality of distributed accelerator cores comprise heterogeneous accelerator cores.

Example 16 includes one or more examples, and includes at least one non-transitory computer-readable medium, comprising instructions stored thereon, that if executed by one or more processors, cause the one or more processors to: select an accelerator core from among an accelerator core associated with a processor and a plurality of accelerator cores to perform at least one operation based on accelerator core utilization and wherein the accelerator core and the plurality of accelerator cores perform encryption, decryption, compression, and/or decompression operations.

Example 17 includes one or more examples, wherein the plurality of accelerator cores are positioned in a plurality of devices coupled to the processor by associated device interfaces.

Example 18 includes one or more examples, and includes instructions stored thereon, that if executed by one or more processors, cause the one or more processors to: select the accelerator core from among the accelerator core and the plurality of accelerator cores to perform the at least one operation based on a priority level of the at least one operation.

Example 19 includes one or more examples, and includes instructions stored thereon, that if executed by one or more processors, cause the one or more processors to: select the accelerator core from among the accelerator core and the plurality of accelerator cores to perform second at least one operation.

Example 20 includes one or more examples, and includes instructions stored thereon, that if executed by one or more processors, cause the one or more processors to: based on a priority of the at least one operation being higher than a priority of the second at least one operation, the processor selecting the accelerator core with a lower accelerator core utilization than a second accelerator core to perform the at least one operation and based on the priority of the second at least one operation being higher than the priority of the at least one operation, the processor selecting multiple accelerator cores to perform the second at least one operation.

1. An apparatus comprising:
a processor comprising a general purpose processor core and an accelerator core and
a plurality of distributed accelerator cores coupled to the processor, wherein the processor is to select an accelerator core from among the accelerator core and the plurality of distributed accelerator cores to perform at least one operation based on accelerator core utilization and wherein the accelerator core and the plurality of distributed accelerator cores perform encryption, decryption, compression, and/or decompression operations.

2. The apparatus of claim 1, wherein the plurality of distributed accelerator cores are positioned in a plurality of devices coupled to the processor by associated device interfaces.

3. The apparatus of claim 1, wherein the processor is to select the accelerator core from among the accelerator core and the plurality of distributed accelerator cores to perform the at least one operation based on a priority level of the at least one operation.

4. The apparatus of claim 1, wherein the processor is to select a second accelerator core from among the accelerator core and the plurality of distributed accelerator cores to perform second at least one operation based on accelerator core utilization.

5. The apparatus of claim 4, wherein based on a priority of the at least one operation being higher than a priority of the second at least one operation, the processor is to select the accelerator core with a lower accelerator core utilization than a utilization of the second accelerator core.

6. The apparatus of claim 4, wherein based on a priority of the at least one operation being higher than a priority of the second at least one operation, the processor is to select multiple accelerator cores to perform the at least one operation.

7. The apparatus of claim 1, wherein the accelerator core and the plurality of distributed accelerator cores comprise heterogeneous accelerator cores.

8. The apparatus of claim 1, comprising:
a package that encapsulates the general purpose processor core and the accelerator core.

9. A method comprising:
selecting an accelerator core from among an accelerator core associated with a processor and a plurality of distributed accelerator cores to perform at least one operation based on accelerator core utilization and wherein the accelerator core and the plurality of distributed accelerator cores perform encryption, decryption, compression, and/or decompression operations, wherein a package encompasses the accelerator core and the processor.

10. The method of claim 9, wherein the plurality of distributed accelerator cores are positioned in a plurality of devices coupled to the processor by associated device interfaces.

11. The method of claim 9, comprising:
the processor selecting the accelerator core from among the accelerator core and the plurality of distributed accelerator cores to perform the at least one operation based on a priority level of the at least one operation.

12. The method of claim 9, comprising:
the processor selecting a second accelerator core from among the accelerator core and the plurality of distributed accelerator cores to perform second at least one operation.

13. The method of claim 12, comprising:
based on a priority of the at least one operation being higher than a priority of the second at least one operation, the processor selecting the accelerator core with a lower accelerator core utilization than second accelerator core to perform the at least one operation and
based on the priority of the second at least one operation being higher than the priority of the at least one operation, the processor selecting multiple accelerator cores to perform the second at least one operation.

14. The method of claim 12, wherein based on a priority of the at least one operation being higher than a priority of the second at least one operation, the processor selecting multiple accelerator cores to perform the at least one operation.

15. The method of claim 9, wherein the accelerator core and the plurality of distributed accelerator cores comprise heterogeneous accelerator cores.

16. At least one non-transitory computer-readable medium, comprising instructions stored thereon, that if executed by one or more processors, cause the one or more processors to:
select an accelerator core from among an accelerator core associated with a processor and a plurality of accelerator cores to perform at least one operation based on accelerator core utilization and wherein the accelerator core and the plurality of accelerator cores perform encryption, decryption, compression, and/or decompression operations.

17. The computer-readable medium of claim 16, wherein the plurality of accelerator cores are positioned in a plurality of devices coupled to the processor by associated device interfaces.

18. The computer-readable medium of claim 16, comprising instructions stored thereon, that if executed by one or more processors, cause the one or more processors to:
select the accelerator core from among the accelerator core and the plurality of accelerator cores to perform the at least one operation based on a priority level of the at least one operation.

19. The computer-readable medium of claim 16, comprising instructions stored thereon, that if executed by one or more processors, cause the one or more processors to:
select the accelerator core from among the accelerator core and the plurality of accelerator cores to perform second at least one operation.

20. The computer-readable medium of claim 19, comprising instructions stored thereon, that if executed by one or more processors, cause the one or more processors to:
based on a priority of the at least one operation being higher than a priority of the second at least one operation, the processor selecting the accelerator core with a lower accelerator core utilization than a second accelerator core to perform the at least one operation and
based on the priority of the second at least one operation being higher than the priority of the at least one operation, the processor selecting multiple accelerator cores to perform the second at least one operation.
